(19) United States
(12) Patent Application Publication
(10) Pub. No.: US 2024/0336794 A1
(43) Pub. Date: Oct. 10, 2024

(54) INK SET, INKJET RECORDING APPARATUS, AND INKJET RECORDING METHOD

(71) Applicant: KYOCERA Document Solutions Inc., Osaka (JP)

(72) Inventor: Noriaki OZAWA, Osaka-shi (JP)

(73) Assignee: KYOCERA Document Solutions Inc., Osaka (JP)

(21) Appl. No.: 18/630,774

(22) Filed: Apr. 9, 2024

(30) Foreign Application Priority Data
Apr. 10, 2023 (JP) 2023-063453

(51) Int. Cl. C09D 11/322; C09D 11/54

(52) U.S. Cl. CPC C09D 11/322; C09D 11/54

(57) ABSTRACT

An ink set includes an inkjet ink and a pretreatment liquid. The inkjet ink contains a pigment, a pigment coating resin, and a first aqueous medium. The first aqueous medium contains water, triethylene glycol monobutyl ether, and a diol with a carbon number of 6. The pretreatment liquid contains a monovalent salt, a divalent salt, and a second aqueous medium. The monovalent salt includes at least one of sodium salt, lithium salt, and potassium salt. The divalent salt includes at least one of calcium salt and magnesium salt. The ratio of the mass of the divalent salt to the mass of the monovalent salt is at least 4.5 and no greater than 12.0 in the pretreatment liquid.

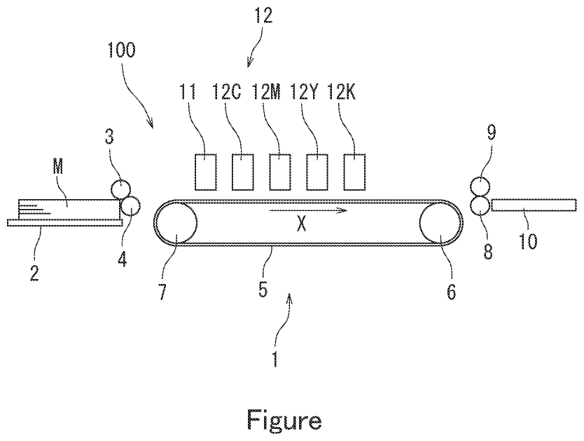

### INCORPORATION BY REFERENCE

The present application claims priority under 35 U.S.C. § 119 to Japanese Patent Application No. 2023-63453, filed on Apr. 10, 2023. The contents of this application are incorporated herein by reference in their entirety.

### BACKGROUND

The present disclosure relates to an ink set, an inkjet recording apparatus, and an inkjet recording method.

Inkjet recording methods are required to form images with desired image density and excellent scratch resistance. To meet such a requirement, an inkjet recording method is proposed in which pretreatment is performed on a recording medium with a pretreatment liquid followed by image formation on the recording medium with an ink. In such an inkjet recording method, use of an ink set is proposed that includes an inkjet ink and a pretreatment liquid containing resin particles, a calcium ion, multiple types of carboxylic acid ions, and water.

### SUMMARY

An inkjet ink according to an embodiment of present disclosure includes an inkjet ink and a pretreatment liquid. The inkjet ink contains a pigment, a pigment coating resin, and a first aqueous medium. The first aqueous medium contains water, triethylene glycol monobutyl ether, and a diol with a carbon number of 6. The pretreatment liquid contains a monovalent salt, a divalent salt, and a second aqueous medium. The monovalent salt includes at least one of sodium salt, lithium salt, and potassium salt. The divalent salt includes at least one of calcium salt and magnesium salt. A ratio of a mass of the divalent salt to a mass of the monovalent salt is at least 4.5 and no greater than 12.0 in the pretreatment liquid.

An inkjet recording apparatus according to another embodiment of the present disclosure is an inkjet recording apparatus that forms an image on an image formation area of a recording medium, and includes: the aforementioned ink set; a line-type pretreatment head that ejects the pretreatment liquid onto the image formation area; and a line-type recording head that ejects the inkjet ink onto the image formation area.

An inkjet recording method according to another embodiment of the present disclosure is an inkjet recording method for forming an image on an image formation area of a recording medium with the aforementioned ink set, and includes: performing pretreatment by ejecting the pretreatment liquid onto the image formation area; and performing image formation by ejecting the inkjet ink onto the image formation area.

### BRIEF DESCRIPTION OF THE DRAWINGS

The FIGURE is a diagram illustrating an example of an inkjet recording apparatus according to a second embodiment.

### DETAILED DESCRIPTION

The following describes embodiments of the present disclosure. Note that measurement values for volume median diameter (D₅₀) are values as measured using a dynamic light scattering type particle size distribution analyzer (“ZETASIZER (registered Japanese trademark) NANO ZS”, product of Malvern Instruments Ltd.) unless otherwise stated.

In the present specification, the term “(meth)acryl” may be used as a generic term for both acryl and methacryl. One type of each component described in the present specification may be used independently, or two or more types of the component may be used in combination.

### First Embodiment: Ink Set

Description is made below of an ink set according to a first embodiment of the present disclosure. The ink set of the present embodiment includes an inkjet ink (also referred to below simply as an ink) and a pretreatment liquid. The ink contains a pigment, a pigment coating resin, and a first aqueous medium. The first aqueous medium contains water, triethylene glycol monobutyl ether, and a diol with a carbon number of 6. The pretreatment liquid contains a monovalent salt, a divalent salt, and a second aqueous medium. The monovalent salt includes at least one of sodium salt, lithium salt, and potassium salt. The divalent salt includes at least one of calcium salt and magnesium salt. The ratio of the mass of the divalent salt to the mass of the monovalent salt is at least 4.5 and no greater than 12.0 in the pretreatment liquid.

The ink set of the present disclosure is preferably used in inkjet recording apparatuses including a line recording head. The inkjet recording apparatuses including a line recording head tend to form images with insufficient image density. However, use of the ink set of the present embodiment can achieve formation of images with desired image density even using the inkjet recording apparatuses including a line recording head.

The pretreatment liquid included in the ink set of the present embodiment is used for application onto image formation areas of recording media. Examples of methods for applying the pretreatment liquid onto image formation areas of recording media include application using a roller, application by spraying, and application by ink jetting. Among the application methods, the application by ink jetting is preferable.

The recording media on which images are to be formed with the ink set of the present embodiment are not limited particularly. Examples thereof include permeable recording media (e.g., copier paper and printer paper).

With the above-described features, the ink set of the present embodiment can form images with desired image density and excellent scratch resistance. The reasons for this can be inferred as follows. The pretreatment liquid included in the ink set of the present embodiment contains a monovalent salt and a divalent salt. Pigments contained in inks are usually anionic pigments. When a recording medium is pretreated with a pretreatment liquid containing a monovalent salt and a divalent salt, cations present in the monovalent salt and the divalent salt cause the pigment in the ink to agglomerate around the surface of the recording medium. As such, the ink set of the present embodiment can cause the pigment to stay around the surface of the recording medium to achieve formation of images with desired image density. By contrast, use of a known ink set tends to establish a trade-off relationship between image density and scratch resistance of formed images. This is because if an attempt is made to keep the pigment near the surface of the recording medium through pretreatment, the amount of pigment present on the outermost layer of the recording medium will increase, resulting in decreased scratch resistance of the images.

By contrast, the ink set of the present embodiment can achieve both image density and scratch resistance of formed images by the pretreatment liquid containing the monovalent salt and the divalent salt at the specific ratio. In detail, the divalent salt of the salts has relatively high reactivity with pigments and can effectively agglomerate the pigments. However, the divalent salt, due to its high hydrophilicity, has the characteristic of reduced reactivity with pigments in hydrophobic environments. On the other hand, the monovalent salt has relatively low reactivity with pigments, and cannot effectively agglomerate the pigments. The monovalent salt, due to its low hydrophilicity, can maintain reactivity with pigments even in hydrophobic environments. In use of the ink set of the present embodiment, when the ink lands on a recording medium treated with the pretreatment liquid, the water in the ink dries and creates a hydrophobic environment on the outermost layer of the recording medium. It is mainly the monovalent salt that agglomerates the pigment in such an environment. However, the monovalent salt does not very effectively agglomerate the pigment as stated above. By contrast, the water present in the ink is retained without complete drying at a site slightly within the outermost layer of the recording medium to create a hydrophilic environment. In such an environment, the divalent salt effectively agglomerates the pigment. As a result, in images formed with the ink set of the present embodiment, a significant amount of the pigment stays slightly within the outermost layer of the recording medium while only a small amount of pigment is retained on the outermost layer. Thus, the ink set of the present embodiment can achieve both image density and scratch resistance of formed images.

Furthermore, the ink included in the ink set of the present embodiment contains triethylene glycol monobutyl ether and a diol with a carbon number of 6. The diol with a carbon number of 6 and triethylene glycol monobutyl ether impart excellent permeability into recording media to the ink. Note that diols with a higher carbon number can impart better penetrability into recording media to ink. However, diols with a carbon number of at least 7 have low solubility in water. Taking account of the above, a carbon number of 6 is considered optimal for the diol. As a result of the ink containing triethylene glycol monobutyl ether and a diol with a carbon number of 6, the ink set of the present embodiment can achieve an even higher level of both image density and scratch resistance in formed images. Details of the ink and the pretreatment liquid included in the ink set of the present embodiment are described below.

### [Ink]

The ink contains a pigment, a pigment coating resin, and a first aqueous medium. Preferably, the ink further contains a surfactant.

### (Pigment)

The pigment in the ink constitutes pigment particles together with the pigment coating resin, for example. The pigment particles each include a core containing the pigment and a pigment coating resin covering the core, for example. The pigment coating resin is present in a dispersed state in the first aqueous medium, for example. In terms of optimizing color density, hue, or stability of the ink, the pigment particles have a volume median diameter of preferably at least 30 nm and no greater than 200 nm, and more preferably at least 70 nm and no greater than 130 nm.

Examples of the pigment include yellow pigments, orange pigments, red pigments, blue pigments, violet pigments, and black pigments. Examples of the yellow pigments include C.I. Pigment Yellow (74, 93, 95, 109, 110, 120, 128, 138, 139, 151, 154, 155, 173, 180, 185, or 193). Examples of the orange pigments include C.I. Pigment Orange (34, 36, 43, 61, 63, or 71). Examples of the red pigments include C.I. Pigment Red (122 or 202). Examples of the blue pigments include C.I. Pigment Blue (15, more specifically 15:3). Examples of the violet pigments include C.I. Pigment Violet (19, 23, or 33). Examples of the black pigments include C.I. Pigment Black (7).

The pigment has a percentage content of preferably at least 1.0% by mass and no greater than 12.0% by mass in the ink, and more preferably at least 4.0% by mass and no greater than 8.0% by mass. As a result of the percentage content of the pigment being set to at least 1.0% by mass, images with desired image density can be formed with the ink set of the present embodiment. As a result of the percentage content of the pigment particles being set to no greater than 12.0% by mass by contrast, fluidity of the ink can be ensured.

### (Pigment Coating Resin)

The pigment coating resin is a resin soluble in the first aqueous medium of the ink. A portion of the pigment coating resin is present on the surfaces of the pigment particles, for example, to optimize dispersibility of the pigment particles. Another portion of the pigment coating resin is present in a dissolved state in the first aqueous medium of the ink, for example.

The pigment coating resin is preferably styrene-(meth)acrylic resin. The styrene-(meth)acrylic resin includes a repeating unit derived from styrene and a repeating unit derived from at least one monomer of (meth)acrylic acid alkyl ester and (meth)acrylic acid. Example of the (meth)acrylic acid alkyl ester include methyl (meth)acrylate, ethyl (meth)acrylate, propyl (meth)acrylate, and butyl (meth)acrylate. The styrene-(meth)acrylic resin is preferably a copolymer (X) of styrene, methyl methacrylate, methacrylic acid, and butyl acrylate. Note that the copolymer (X) is preferably neutralized with an equal amount of bases (e.g., potassium hydroxide and sodium hydroxide).

The percentage content of the repeating unit derived from styrene is preferably at least 10% by mass and no greater than 20% by mass in all repeating units of the copolymer (X). The percentage content of the repeating unit derived from methyl methacrylate is preferably at least 10% by mass and no greater than 20% by mass in all the repeating units of the copolymer (X). The percentage content of the repeating unit derived from methacrylic acid is preferably at least 35% by mass and no greater than 45% by mass in all the repeating units of the copolymer (X). The percentage content of the repeating unit derived from butyl acrylate is preferably at least 25% by mass and no greater than 35% by mass in all the repeating units of the copolymer (X).

The percentage content of the pigment coating resin is preferably at least 0.5% by mass and no greater than 6.0% by mass in the ink, and more preferably at least 1.5% by mass and no greater than 4.0% by mass. As a result of the percentage content of the pigment coating resin being set to at least 0.5% by mass and no greater than 6.0% by mass, ejection stability of the ink can be optimized.

The content of the pigment coating resin is preferably at least 10 parts by mass and no greater than 80 parts by mass relative to 100 parts by mass of the pigment in the ink, and more preferably at least 30 parts by mass and no greater than 50 parts by mass. As a result of the content of the pigment coating resin being set to at least 10 parts by mass and no greater than 80 parts by mass, ejection stability of the ink can be optimized.

### (First Aqueous Medium)

The first aqueous medium contained in the ink contains water, triethylene glycol monobutyl ether, and a diol with a carbon number of 6. The first aqueous medium may function as a solvent or a dispersion medium. The first aqueous medium may further contain a water-soluble organic solvent (also referred to below as an optional water-soluble organic solvent) other than the triethylene glycol monobutyl ether and the diol with a carbon number of 6.

### (Water)

The percentage content of the water is preferably at least 40.0% by mass and no greater than 80.0% by mass in the ink, and more preferably at least 55.0% by mass and no greater than 67.0% by mass.

(Diol with Carbon Number of 6)

The diol with a carbon number of 6 imparts permeability into recording media to the ink. The diol with a carbon number of 6 may have a linear chain structure or a branched chain structure. The diol with a carbon number of 6 preferably has a branched chain structure in view of its high affinity with water. Examples of the diol with a carbon number of 6 include 1,2-hexanediol, 1,3-hexanediol, 1,4-hexanediol, 1,6-hexanediol, 2,4-hexanediol, 2,5-hexanediol, 2-methyl-2,4-pentanediol, and 3-methyl-1,5-pentanediol. The diol with a carbon number of 6 is preferably 1,6-hexanediol or 3-methyl-1,5-pentanediol, and more preferably 3-methyl-1,5-pentanediol.

The diol with a carbon number of 6 has a percentage content of preferably at least 5.0% by mass and no greater than 40.0% by mass in the ink, and more preferably at least 15.0% by mass and no greater than 25.0% by mass. As a result of the percentage content of the diol with a carbon number of 6 being set to at least 5.0% by mass, permeability of the ink into recording media can be further optimized. As a result of the percentage content of the diol with a carbon number of 6 being set to no greater than 40.0% by mass, ejection stability of the ink can be optimized.

### (Triethylene Glycol Monobutyl Ether)

The triethylene glycol monobutyl ether imparts permeability into recording media to the ink. The triethylene glycol monobutyl ether has a percentage content of preferably at least 1.0% by mass and no greater than 10.0% by mass in the ink, and more preferably at least 3.0% by mass and no greater than 7.0% by mass. As a result of the percentage content of the triethylene glycol monobutyl ether being set to at least 1.0% by mass, permeability of the ink into recording media can be further optimized. As a result of the percentage content of the triethylene glycol monobutyl ether being set to no greater than 10.0% by mass, ejection stability of the ink can be optimized.

### (Optional Water-Soluble Organic Solvent)

Examples of the optional water-soluble organic solvent that can be contained in the first aqueous medium include glycol compounds with a carbon number of at least 1 and no greater than 5, glycol ether compounds (except triethylene glycol monobutyl ether), lactam compounds, nitrogen-containing compounds, acetate compounds, thiodiglycol, glycerin, and dimethyl sulfoxide.

The optional water-soluble organic solvent is preferably glycerin. As a result of the ink containing glycerin, moisturizing properties and ejection stability of the ink can be optimized. The percentage content of the glycerin is preferably at least 2.0% by mass and no greater than 10.0% by mass in the ink, and more preferably at least 4.0% by mass and no greater than 6.0% by mass. As a result of the percentage content of the glycerin being set to at least 4.0% by mass and no greater than 6.0% by mass, moisturizing properties and ejection stability of the ink can be further optimized.

The first aqueous medium preferably contains only water, a diol with a carbon number of 6, triethylene glycol monobutyl ether, and glycerin. The total percentage content of the water, the diol with a carbon number of 6, triethylene glycol monobutyl ether, and glycerin is preferably at least 90% by mass in the first aqueous medium, more preferably at least 99% by mass, and further preferably 100% by mass.

The percentage content of the first aqueous medium is preferably at least 70.0% by mass and no greater than 97.0% by mass in the ink, and more preferably at least 85.0% by mass and no greater than 95.0% by mass.

### (Surfactant)

The surfactant optimizes compatibility and dispersion stability of the components contained in the ink. The surfactant also optimizes wettability of the ink to recording media. A nonionic surfactant is preferable as the surfactant in the ink.

Examples of the nonionic surfactant in the ink include acetylene glycol surfactants (surfactants containing an acetylene glycol compound), silicone surfactants (surfactants containing a silicone compound), and fluorine surfactants (surfactants containing fluororesin or a fluorine-containing compound). Examples of the acetylene glycol surfactants include ethylene oxide adducts of acetylene glycol and propylene oxide adducts of acetylene glycol. The nonionic surfactant is preferably an acetylene glycol surfactant.

The percentage content of the surfactant is preferably at least 0.1% by mass and no greater than 2.0% by mass in the ink, and more preferably at least 0.2% by mass and no greater than 0.5% by mass.

### (Optional Components)

The ink may further contain any known additives (e.g., a solution stabilizer, an anti-drying agent, an antioxidant, a viscosity modifier, a pH adjuster, and an antifungal agent) as necessary.

In view of ejection stability and the like, the ink preferably does not contain resin particles. The percentage content of the resin particles is preferably no greater than 5.0% by mass in the ink, more preferably no greater than 1.0% by mass, and further preferably 0.0% by mass.

Compositions a and b are shown below in Table 1 as preferable compositions of the ink. In Table 1 below, the entry “5.0-7.0” under “Pigment” for the composition a indicates that the pigment is contained in a range of at least 5.0% by mass and no greater than 7.0% by mass. The same applies to the other entries. “Resin” refers to pigment coating resin. “BTG” refers to triethylene glycol monobutyl ether. “MPD” refers to 3-methyl-1,5-pentanediol. “1,6HD” refers to 1,6-hexanediol.

TABLE 1

| | Pigment | Resin | BTG | MPD | 1,6HD | Glycerin | Surfactant | Water |
|---|---|---|---|---|---|---|---|---|
| a | 5.0-7.0 | 2.0-3.0 | 4.0-6.0 | 18.0-22.0 | — | 4.0-6.0 | 0.2-0.5 | Rest |
| b | 5.0-7.0 | 2.0-3.0 | 4.0-6.0 | — | 18.0-22.0 | 4.0-6.0 | 0.2-0.5 | Rest |

### (Ink Production Method)

The ink can be produced for example by uniformly mixing a pigment dispersion containing the pigment and the pigment coating resin, a diol with a carbon number of 6, triethylene glycol monobutyl ether, and any optional components (e.g., water and the surfactant) added as necessary using a stirrer. In production of the ink, uniform mixing of the components may be followed by removal of foreign matter and coarse particles using a filter (e.g., a filter with a pore size of no greater than 5 μm).

### (Pigment Dispersion)

The pigment dispersion is a dispersion containing the pigment and the pigment coating resin. The dispersion medium of the pigment dispersion is preferably water.

The percentage content of the pigment is preferably at least 5.0% by mass and no greater than 25.0% by mass in the pigment dispersion, and more preferably at least 10.0% by mass and no greater than 20.0% by mass. The percentage content of the pigment coating resin is preferably at least 1.0% by mass and no greater than 12.0% by mass in the pigment dispersion, and more preferably at least 4.0% by mass and no greater than 8.0% by mass.

The pigment dispersion can be prepared by wet dispersion of the pigment, the pigment coating resin, a dispersion medium (e.g., water), and a component (e.g., the surfactant) added as necessary using a media-type wet disperser. In wet dispersion using a media-type wet disperser, small-diameter beads (e.g., beads with a D₅₀ of at least 0.5 mm and no greater than 1.0 mm) can be used as a medium, for example. The material of the beads is not particularly limited, and is preferably a hard material (e.g., glass or zirconia).

### [Pretreatment Liquid]

The pretreatment liquid contains a monovalent salt, a divalent salt, and a second aqueous medium. The ratio of the mass of the divalent salt to the mass of the monovalent salt is at least 4.5 and no greater than 12.0 in the pretreatment liquid, more preferably at least 6.0 and no greater than 11.0, and further preferably at least 8.0 and no greater than 11.0. As a result of the ratio of the mass of the divalent salt to the mass of the monovalent salt being set to at least 4.5, the ink set of the present embodiment can impart desired image density and scratch resistance to formed images. As a result of the ratio of the mass of the divalent salt to the mass of the monovalent salt being set to no greater than 12.0, the ink set of the present embodiment can impart scratch resistance to formed images.

### (Monovalent Salt)

The monovalent salt includes at least one of sodium salt, lithium salt, and potassium salt. Examples of the anion in the monovalent salt include F⁻, Cl⁻, OH⁻, and NO₃⁻. The anion in the monovalent salt is preferably Cl⁻. The monovalent salt is preferably sodium chloride, lithium chloride, or potassium chloride.

The monovalent salt has a percentage content of preferably at least 0.5% by mass and no greater than 6.0% by mass in the pretreatment liquid, and more preferably at least 1.0% by mass and no greater than 3.0% by mass. As a result of the percentage content of the monovalent salt being set to at least 0.5% by mass, the ink set of the present embodiment can optimize scratch resistance of formed image. As a result of the percentage content of the monovalent salt being set to no greater than 6.0% by mass, the ink set of the present embodiment can optimize scratch resistance and image density of formed image.

### (Divalent Salt)

The divalent salt includes at least one of calcium salt and magnesium salt. Example of the anion in the divalent salt include O₂⁻, S₂⁻, SO₄²⁻, and CO₃²⁻. The anion in the divalent salt is preferably SO₄²⁻. The divalent salt is preferably calcium sulfate or magnesium sulfate.

The divalent salt has a percentage content of preferably at least 3.0% by mass and no greater than 20.0% by mass in the pretreatment liquid, and more preferably at least 5.0% by mass and no greater than 15.0% by mass. As a result of the percentage content of the divalent salt being set to at least 3.0% by mass, the ink set of the present embodiment can optimize image density of formed image. As a result of the percentage content of the divalent salt being set to no greater than 20.0% by mass, the ink set of the present embodiment can optimize scratch resistance of formed image.

### (Second Aqueous Medium)

The second aqueous medium contained in the pretreatment liquid is a medium containing water. The second aqueous medium may function as a solvent or a dispersion medium. Specific examples of the second aqueous medium include aqueous media containing only water and aqueous media containing water and a water-soluble organic solvent. When applying the pretreatment liquid onto a recording medium by ink jetting, it is preferable for the second aqueous medium to contain water and a water-soluble organic solvent to impart ejection stability of the pretreatment liquid. For applying the pretreatment liquid onto a recording medium by a method (e.g., using a roller or by spraying) other than by ink jetting, the second aqueous medium preferably contains only water.

### (Water)

The percentage content of the water is preferably at least 60.0% by mass and no greater than 90.0% by mass in the pretreatment liquid, and more preferably at least 73.0% by mass and no greater than 85.0% by mass.

### (Water-Soluble Organic Solvent)

Examples of the water-soluble organic solvent in the second aqueous medium include compounds similar to the water-soluble organic solvents (specifically, diols with a carbon number of 6, triethylene glycol monobutyl ether, and the optional water-soluble organic solvent) exemplified for the ink. The water-soluble organic solvent in the second aqueous medium is preferably glycerin. That is, the second aqueous medium preferably contains water and glycerin.

The percentage content of the glycerin is preferably at least 3.0% by mass and no greater than 20.0% by mass in the pretreatment liquid, and more preferably at least 8.0% by mass and no greater than 12.0% by mass.

Preferably, the second aqueous medium contains only water or contains only water and glycerin. The total percentage content of the water and the glycerin is preferably at least 90% by mass in the second aqueous medium, more preferably at least 99% by mass, and further preferably 100% by mass.

### (Optional Components)

The pretreatment liquid may further contain any known additives (e.g., a surfactant, a solution stabilizer, an anti-drying agent, an antioxidant, a viscosity modifier, a pH adjuster, and an antifungal agent) as necessary.

Preferably, the pretreatment liquid contains only the monovalent salt, the divalent salt, and the second aqueous medium. The total percentage content of the monovalent salt, the divalent salt, and the second aqueous medium is preferably at least 90% by mass in the second aqueous medium, more preferably at least 99% by mass, and further preferably 100% by mass.

In particular, the pretreatment liquid preferably contains only the monovalent salt and the divalent salt as solid contents. The percentage content of a solid content (e.g., a resin) other than the monovalent salt and the divalent salt is preferably no greater than 3% by mass in the pretreatment liquid, more preferably no greater than 1% by mass, and further preferably 0% by mass.

Compositions A to F are shown below in Table 2 as preferable compositions of the pretreatment liquid. In Table 2 below, the entry “1.5-2.5” under “KCl” for the composition A indicates that potassium chloride is contained in a range of at least 1.5% by mass and no greater than 2.5% by mass. The same applies to the other entries.

TABLE 2

| | NaCl | KCl | LiCl | CaSO₄ | MgSO₄ | Glycerin | Water |
|---|---|---|---|---|---|---|---|
| A | — | 1.5-2.5 | — | — | 9.0-11.0 | 9.0-11.0 | Rest |
| B | 1.5-2.5 | — | — | 9.0-11.0 | — | 9.0-11.0 | Rest |
| C | 1.5-2.5 | — | — | — | 9.0-11.0 | 9.0-11.0 | Rest |
| D | — | — | 1.5-2.5 | — | 9.0-11.0 | 9.0-11.0 | Rest |
| E | 0.5-1.5 | — | — | — | 9.0-11.0 | 9.0-11.0 | Rest |
| F | 0.5-1.5 | — | — | — | 6.0-8.0 | 9.0-11.0 | Rest |

### (Pretreatment Liquid Preparation Method)

The pretreatment liquid can be produced for example by uniformly mixing the monovalent salt, the divalent salt, and the second aqueous medium using a stirrer. In production of the pretreatment liquid, uniform mixing of the components may be followed by removal of foreign matter and coarse particles using a filter (e.g., a filter with a pore size of no greater than 5 μm).

### Second Embodiment: Inkjet Recording Apparatus

Next, an inkjet recording apparatus of a second embodiment is described. The inkjet recording apparatus of the present embodiment is an inkjet recording apparatus that forms an image on an image formation area of a recording medium, and includes the ink set of the first embodiment, a line-type pretreatment head that ejects the pretreatment liquid onto the image formation area, and a line-type recording head that ejects the ink onto the image formation area. The inkjet recording apparatus of the present embodiment uses the ink set of the first embodiment, allowing formation of images with desired image density and excellent scratch resistance. Note that redundant explanations of the ink set, as described in the first embodiment, are omitted in the present embodiment.

With reference to the drawing, the inkjet recording apparatus of the present embodiment is described below. The drawing to be referenced schematically illustrates elements of configuration in order to facilitate understanding. Properties such as the size and the number of the elements of configuration illustrated in the drawing may differ from actual properties and the number thereof in order to facilitate preparation of the drawings.

The FIGURE is a diagram illustrating main elements of an inkjet recording apparatus 100 which is an example of the inkjet recording apparatus of the present disclosure. As illustrated in the FIGURE, the inkjet recording apparatus 100 mainly includes a conveyance section 1, a line-type pretreatment head 11, and line-type recording heads 12. The line-type pretreatment head 11 is loaded with the pretreatment liquid. The line-type recording heads 12 are loaded with the ink. The inkjet recording apparatus 100 further includes a sheet feed tray 2, a sheet feed roller 3, a sheet feed driven roller 4, a conveyor belt 5, a belt drive roller 6, a belt driven roller 7, an ejection roller 8, an ejection driven roller 9, and an exit tray 10. The conveyor belt 5, the belt drive roller 6, and the belt driven roller 7 constitute a part of the conveyance section 1. The sheet feed tray 2 is provided at the left end in the drawing of the inkjet recording apparatus 100. The sheet feed tray 2 accommodates recording medium sheets M. The sheet feed roller 3 and the sheet feed driven roller 4 are provided at one end of the sheet feed tray 2. The sheet feed roller 3 picks up the accommodated recording medium sheets M sequentially one by one starting from the uppermost recording medium sheet M and feeds it onto the conveyor belt 5. The sheet feed driven roller 4 is pressed against the sheet feed roller 3 to be rotationally driven.

The conveyor belt 5 is provided in a rotatable manner downstream (rightward in the FIGURE) of the sheet feed roller 3 and the sheet feed driven roller 4 in terms of a direction in which the recording medium sheet M is conveyed (also referred to below as a sheet conveyance direction). The conveyor belt 5 is wound between the belt drive roller 6 and the belt driven roller 7. The belt drive roller 6 is provided downstream of the belt driven roller 7 in terms of the sheet conveyance direction. The belt drive roller 6 drives the conveyor belt 5. The belt driven roller 7 is provided upstream of the belt drive roller 6 in terms of the sheet conveyance direction. The belt driven roller 7 is rotated following the belt drive roller 6 through the conveyor belt 5. Rotational driving of the belt drive roller 6 in the clockwise direction in the FIGURE conveys the recording medium sheet M in a conveyance direction X indicated by the arrow in the FIGURE.

The ejection roller 8 and the ejection driven roller 9 are provided downstream of the conveyor belt 5 in terms of the sheet conveyance direction. The ejection roller 8 is driven clockwise in the FIGURE to eject the recording medium sheet M with an image formed thereon out of the apparatus casing. The ejection driven roller 9 is pressed against the upper part of the ejection roller 8 to be rotationally driven. The exit tray 10 is provided downstream of the ejection roller 8 and the ejection driven roller 9 in terms of the sheet conveyance direction. The recording medium sheet M ejected out of the apparatus casing is placed on the exit tray 10.

The line-type pretreatment head 11 is provided above the conveyor belt 5. The line-type pretreatment head 11 ejects the pretreatment liquid onto an image formation area of the recording medium sheet M conveyed on the conveyor belt 5. In the manner as above, the line-type pretreatment head 11 performs pretreatment on the image formation area of the recording medium sheet M.

The line-type recording heads 12 are provided downstream of the line-type pretreatment head 11 in terms of the sheet conveyance direction. The line-type recording heads 12 include line-type recording heads 12C, 12M, 12Y, and 12K. The line-type recording heads 12C, 12M, 12Y, 12K are provided above the conveyor belt 5 in the stated order from upstream to downstream in terms of the sheet conveyance direction. The line-type recording heads 12C to 12K are each supported at a height where the distance from the upper surface of the conveyor belt 5 is a specific length. The line-type recording heads 12C to 12K form an image on the recording medium sheet M conveyed on the conveyor belt 5. The line-type recording heads 12C to 12K accommodate 4 color inks with mutually different colors (cyan, magenta, yellow, and black). The inkjet recording apparatus 100 ejects the color inks from the respective line-type recording heads 12C to 12K to form a color image on the recording medium sheet M.

One example of the inkjet recording apparatus of the present embodiment has been described so far. However, the inkjet recording apparatus of the present embodiment is not limited to that illustrated in the FIGURE.

The FIGURE refers to the inkjet recording apparatus 100 including four line-type recording heads 12C to 12K corresponding to the four color inks as an example. However, the number of the line-type recording heads included in the inkjet recording apparatus of the present embodiment is not particularly limited, as long as it is at least 2. It may be at least 2 and no greater than 10, preferably at least 3 and no greater than 5.

The inkjet recording apparatus 100 ejects inks of 4 colors of cyan, magenta, yellow, and black in the stated order. However, the type, combination, and ejection order of the inks are not limited to these.

In addition, the inkjet recording apparatus of the present embodiment may be a multifunction peripheral having additional functions of any of a scanner, a copier, a printer, and a facsimile machine.

### Third Embodiment: Inkjet Recording Method

Next, an inkjet recording method of a third embodiment is described. The inkjet recording method of the present embodiment is an inkjet recording method for forming an image on an image formation area of a recording medium with the ink set of the first embodiment, and includes a pretreatment process of performing pretreatment by ejecting the pretreatment liquid onto the image formation area and an image formation process of performing image formation by ejecting the ink onto the image formation area. The inkjet recording apparatus of the present embodiment uses the ink set of the first embodiment to achieve formation of images with desired image density and excellent scratch resistance. Note that redundant explanations of the ink set, as described in the first embodiment, are omitted in the present embodiment.

### [Pretreatment Process]

In the present process, the pretreatment liquid is ejected onto the recording medium. The method for ejecting the pretreatment liquid onto the recording medium is not limited particularly and may be a method using a piezoelectric head or a thermal inkjet head.

In the present process, the pretreatment liquid may be ejected onto only an area of the surface of the recording medium where the ink is to be ejected or the entire surface of the recording medium.

In the present process, the application amount of the pretreatment liquid is at least 3.5 g/m² and no greater than 7.0 g/m², for example. In the present process, the application amount per pixel of the pretreatment liquid is at least 10 pL and no greater than 20 pL, for example.

### [Image Formation Process]

In the present process, the ink is ejected onto the recording medium after the pretreatment process, thereby forming an intended image. The ink ejection method is not limited particularly and may be a method using a piezoelectric head or a thermal inkjet head.

### Examples

The following describes examples of the present disclosure. However, the present disclosure is not limited to the following examples.

In the present examples, values for volume median diameter (D₅₀) are values measured using a dynamic light scattering type particle size distribution analyzer (“ZETASIZER (registered Japanese trademark) NANO ZS”, product of Malvern Instruments Ltd.). Note that a measurement target was diluted with ion exchange water as necessary for measurement.

### <Evaluation Methods>

Image density and scratch resistance of images formed with ink sets each being an evaluation target were evaluated by the following methods in the examples.

### [Evaluation Apparatus]

A prototype produced by KYOCERA Document Solutions Japan Inc. was used as an evaluation apparatus. The evaluation apparatus included a line-type pretreatment head that ejects a pretreatment liquid onto an image formation area of a recording medium and a line-type recording head that ejects an ink onto the image formation area of the recording medium. The line-type pretreatment head was set up so that the ejection amount of the pretreatment liquid to be ejected per pixel was 13 pL. The line-type recording head was set up so that the volume of each droplet of the ink to be ejected was 10 pL (i.e., the ink volume per pixel was 10 pL).

### [Evaluation of Image Density]

Evaluation of image density was performed in an environment at a temperature of 25° C. and a relative humidity of 50%. In the evaluation of image density, sheets of A4-size plain paper (“COLOR COPY (registered Japanese trademark)”, product of Mondi, basis weight: 90 g/m²) were used as recording medium sheets. A pretreatment liquid (in detail, a pretreatment liquid included in any of the ink sets each being the evaluation target) was ejected onto an image formation area of a recording medium sheet using the line-type pretreatment head of the evaluation apparatus. Next, an ink (in detail, a corresponding ink included in the ink set being the evaluation target) was ejected onto the image formation area of the recording medium sheet using the line-type recording head of the evaluation apparatus to form a solid image with a size of 1 cm by 1 cm on the recording medium sheet. The recording medium sheet was then left to stand for 24 hours. Next, the image density (ID value) of the solid image formed on the recording medium sheet was measured using a fluorescence spectrodensitometer (“FD-5”, product of KONICA MINOLTA, INC.). Image density was evaluated according to the following criteria.

### (Criteria of Image Density)

A (good): ID of at least 1.30
B (poor): ID of less than 1.30

### [Evaluation of Scratch Resistance]

Evaluation of scratch resistance was performed in an environment at a temperature of 28° C. and a relative humidity of 80%. In the evaluation of scratch resistance, sheets of multipurpose printer paper (“VITALITY”, product of FUJIFILM Business Innovation Corp., moisture content: 4% by mass to 6% by mass) were used as recording medium sheets. A pretreatment liquid (in detail, a pretreatment liquid included in any of the ink sets each being the evaluation target) was ejected onto an image formation area of a recording medium sheet using the line-type pretreatment head of the evaluation apparatus. Next, an ink (in detail, a corresponding ink included in the ink set being the evaluation target) was ejected onto the image formation area of the recording medium sheet using the line-type recording head of the evaluation apparatus to form a solid image with a size of 10 cm by 10 cm on the recording medium sheet.

After 10 seconds from the solid image formation, a test sheet (unprinted one sheet of the multipurpose printer paper) was placed on the surface of the recording medium sheet with the solid image formed thereon (surface on the side with the solid image). Using a weight, the solid image on one side of the test sheet was rubbed back and forth five times with a load of 1 kg applied. Thereafter, the image density of the surface of the test sheet on the side having been in contact with the solid image was measured using the aforementioned fluorescence spectrodensitometer. In detail, the image density measurement was performed on 10 randomly selected locations on the surface of the test sheet on the side having been in contact with the solid image. An arithmetic mean of the measured 10 image densities was taken as an evaluation value for scratch resistance. Scratch resistance was evaluated according to the following criteria.

### (Criteria of Scratch Resistance)

A (good): evaluation value of no greater than 0.020
B (poor): evaluation value of greater than 0.020

### [Preparation of Magenta Pigment Dispersion]

A magenta pigment dispersion was prepared for use in ink preparation. In the preparation of the magenta pigment dispersion, a pigment coating resin solution containing a pigment coating resin (R) and water was prepared first.

### (Preparation of Pigment Coating Resin Solution)

An alkali soluble resin was prepared that included a repeating unit (MAA unit) derived from methacrylic acid, a repeating unit (MMA unit) derived from methyl methacrylate, a repeating unit (BA unit) derived from butyl acrylate, and a repeating unit (ST unit) derived from styrene. The alkali soluble resin had a mass average molecular weight (Mw) of 20,000 and an acid value of 100 mgKOH/g. The mass ratio of each repeating unit in the alkali soluble resin was “MAA unit:MMA unit:BA unit:ST unit=40:15:30:15”. The alkali soluble resin and a sodium hydroxide aqueous solution (NaOH concentration: 10% by mass) were mixed (neutralization). The neutralization was carried out with NaOH in an amount 1.05 times that required to neutralize the alkali soluble resin. Thus, a pigment coating resin solution containing a pigment coating resin (R) and water was obtained.

The mass average molecular weight Mw of the alkali soluble resin was measured under the following conditions using a gel permeation chromatography (“HLC-8020GPC”, product of Tosoh Corporation). A calibration curve was plotted using n-propyl benzene and TSKgel standard polystyrenes produced by Tosoh Corporation, F-40, F-20, F-4, F-1, A-5000, A-2500, and A-1000.

### (Conditions for Mass Average Molecular Weight Measurement)

Column: “TSKgel SUPER MULTIPORE HZ-H” produced by Tosoh Corporation (semimicro column with 4.6 mm I.D.×15 cm)
Number of columns: 3
Eluent: tetrahydrofuran
Flow rate: 0.35 mL/min
Sample injection amount: 10 μL
Measurement temperature: 40° C.
Detector: IR detector

### (Preparation of Magenta Pigment Dispersion)

A magenta pigment (C.I. Pigment Red 112), the aforementioned pigment coating resin solution containing the pigment coating resin (R), an acetylene glycol surfactant (“OLFINE (registered Japanese trademark) E1010”, product of Nissin Chemical Industry Co., Ltd., ethylene oxide adduct of acetylene glycol), and ion exchange water were added into a vessel of a media-type wet disperser (“DYNO (registered Japanese trademark)-MILL”, product of Willy A. Bachofen AG (WAB)) to achieve the composition shown below in Table 3.

Note that the percentage content of “Water” below in Table 3 indicates the total percentage content of the ion exchange water added into the vessel and water contained in the pigment coating resin solution (specifically, water contained in the sodium hydroxide aqueous solution used for neutralization of the alkali soluble resin and water produced by the neutralization of the alkali soluble resin and sodium hydroxide).

TABLE 3

| | Percentage content |
|---|---|
| Magenta pigment dispersion | [% by mass] |
| Magenta pigment | 15.0 |
| Pigment coating resin (R) | 6.0 |
| (neutralization of NaOH) | |
| Surfactant | 0.5 |
| Water | Rest |
| Total | 100.0 |

Next, the vessel contents were wet dispersed. The medium used was zirconia beads (particle diameter 1.0 mm). The amount of the medium loaded was 70% by volume relative to the capacity of the vessel. The dispersion conditions included a temperature of 10° C. and a peripheral speed of 8 m/sec. Through the above, the magenta pigment dispersion was obtained.

The volume median diameter (D₅₀) of pigment particles contained in the resulting magenta pigment dispersion was measured. In detail, the resulting magenta pigment dispersion was diluted 300 times with ion exchange water and the resultant was used as a measurement sample. The D₅₀ of the pigment particles in the measurement sample was measured using a dynamic light scattering type particle size distribution analyzer (“ZETASIZER (registered Japanese trademark) NANO ZS”, product of Malvern Instruments Ltd.). The D₅₀ of the pigment particles in the measurement sample was used as the D₅₀ of the pigment particles contained in the magenta pigment dispersion. Note that the measurement was performed 10 times and an average of each measurement result was used as the D₅₀ of the pigment particles. The D₅₀ of the pigment particles contained in the magenta pigment dispersion was 100 nm.

### <Research 1: Research on Diols in Inks>

Inks (I-1) to (I-4) and a pretreatment liquid (P-1) were prepared by the following methods. Any of the inks (I-1) to (I-4) and the pretreatment liquid (P-1) were combined as shown below in Table 4 to prepare ink sets of Examples 1 and 2 and Comparative Examples 1 and 2. Using the ink sets of Examples 1 and 2 and Comparative Examples 1 and 2, the diols in the inks were researched.

### [Preparation of Ink (I-1)]

A beaker was charged with 40.0 parts by mass of the magenta pigment dispersion (magenta pigment: 6.0 parts by mass, the pigment coating resin (R): 2.4 parts by mass), 0.3 parts by mass of a surfactant (“SURFYNOL (registered Japanese trademark) 420”, product of Nissin Chemical Industry Co., Ltd., ethylene oxide adduct of acetylene glycol), 5.0 parts by mass of triethylene glycol monobutyl ether, 20.0 parts by mass of a diol (3-methyl-1,5-pentanediol for the ink (I-1) shown below in Table 4), 5.0 parts by mass of glycerin, and 29.7 parts by mass of ion exchange water. The beaker contents were mixed at a rotational speed of 400 rpm using a stirrer (“THREE-ONE MOTOR BL-600”, product of Shinto Scientific Co., Ltd.) to obtain a mixed liquid. The mixed liquid was filtered using a filter (pore size 5 μm) to remove foreign matter and coarse particles contained in the mixed liquid. Thus, an ink (I-1) was obtained.

### [Preparation of Inks (I-2) to (I-4)]

Inks (I-2) to (I-4) were prepared according to the same method as that for preparing the ink (I-1) in all aspects other than the type of the diol was changed as shown below in Table 4. Explanation of the diols used for preparation of the inks was given below.
1,4-Butanediol: carbon number 4 (straight chain structure)
1,5-Pentanediol: carbon number 5 (straight chain structure)
3-Methyl-1,5-pentanediol: carbon number 6 (branched chain structure)
1,6-Hexanediol: carbon number 6 (straight chain structure)

### [Preparation of Pretreatment Liquid (P-1)]

A mixed liquid was obtained by stirring 10 parts by mass of magnesium sulfate as a divalent salt, 2 parts by mass of potassium chloride as a monovalent salt, 10 parts by mass of glycerin, and 78 parts by mass of water using a stirrer (“THREE-ONE MOTOR BL-600”, product of Shinto Scientific Co., Ltd.). The mixed liquid was filtered using a filter (pore size 5 μm) to remove foreign matter and the like contained in the mixed liquid. Thus, a pretreatment liquid (P-1) was obtained.

Image density and scratch resistance of formed images were evaluated by the aforementioned methods for the ink sets of Examples 1 and 2 and Comparative Examples 1 and 2. The evaluation results are shown below in Table 4.

TABLE 4

| | | | | | | Scratch resistance | |
|---|---|---|---|---|---|---|---|
| | Pretreatment | Ink | | Image density | | Measurement | |
| | liquid | Type | Diol | ID vaue | Rating | value | Rating |
| Example 1 | P-1 | I-1 | 3-Methyl-1,5- | 1.35 | A | 0.018 | A |
| | | | pentanediol | | | | |
| Example 2 | P-1 | I-2 | 1,6-Hexanediol | 1.30 | A | 0.017 | A |
| Comparative | P-1 | I-3 | 1,4-Butanediol | 1.37 | A | 0.024 | B |
| Example 1 | | | | | | | |
| Comparative | P-1 | I-4 | 1,5-Pentanediol | 1.37 | A | 0.025 | B |
| Example 2 | | | | | | | |

As shown in Table 4, 3-methyl-1,5-pentanediol or 1,6-hexanediol was used as the diol in the ink in the ink set of Example 1 or 2. The ink sets of Examples 1 and 2 were rated as good for image density and scratch resistance of the formed images. By contrast, 1,4-butanediol or 1,5-pentanediol was used as the diol in the ink in the ink set of Comparative Example 1 or 2. As a result, the ink sets of Comparative Examples 1 and 2 were rated as poor for scratch resistance of the formed images. From the above, a diol with a carbon number of 6 is determined to be appropriate as the diol in an ink.

The image density of the image formed with the ink set of Example 1 was higher than that formed with the ink set of Example 2. This is thought to be because the 3-methyl-1,5-pentanediol used in the ink set of Example 1 is more hydrophilic than the 1,6-hexanediol used in the ink set of Example 2, due to its branched structure.

### <Research 2: Research on Glycol Ethers in Inks>

Inks (I-5) to (I-7) were prepared by the following methods. Thereafter, any of the inks (I-5) to (I-7) and the pretreatment liquid (P-1) were combined as shown below in Table 5 to prepare ink sets of Example 3 and Comparative Examples 3 and 4. The glycol ethers in the inks were researched using the ink sets of Example 3 and Comparative Examples 3 and 4.

### [Preparation of Ink (I-5)]

A beaker was charged with 40.0 parts by mass of a magenta pigment dispersion (magenta pigment: 6.0 parts by mass, the pigment coating resin (R): 2.4 parts by mass), 0.3 parts by mass of a surfactant (“SURFYNOL (registered Japanese trademark) 420”, product of Nissin Chemical Industry Co., Ltd., ethylene oxide adduct of acetylene glycol), 5.0 parts by mass of a glycol ether (triethylene glycol monobutyl ether for the ink (I-5)) shown below in Table 5, 20.0 parts by mass of 3-methyl-1.5-pentanediol, 5.0 parts by mass of glycerin, and 29.7 parts by mass of ion exchange water. The beaker contents were mixed at a rotational speed of 400 rpm using a stirrer (“THREE-ONE MOTOR BL-600”, product of Shinto Scientific Co., Ltd.) to obtain a mixed liquid. The mixed liquid was filtered using a filter (pore size 5 μm) to remove foreign matter and coarse particles contained in the mixed liquid. Thus, an ink (I-5) was obtained.

### [Preparation of Inks (I-6) and (I-7)]

Inks (I-6) and (I-7) were prepared according to the same method as that for preparing the ink (I-5) in all aspects other than the type of the glycol ether was changed as shown below in Table 5. Note that the abbreviations of the glycol ethers used in the preparation of the inks are shown below.
Triethylene glycol monobutyl ether: BTG
Triethylene glycol monoisopropyl ether: BPG
Triethylene glycol monoethyl ether: BEG

Image density and scratch resistance of formed images were evaluated by the aforementioned methods for the ink sets of Example 3 and Comparative Examples 3 and 4. The evaluation results are shown below in Table 5.

TABLE 5

| | | Ink | | | | Scratch resistance | |
|---|---|---|---|---|---|---|---|
| | Pretreatment | | Glycol | Image density | | Measurement | |
| | liquid | Type | ether | ID value | Rating | value | Rating |
| Example 3 | P-1 | I-6 | BTG | 1.35 | A | 0.016 | A |
| Comparative | P-1 | I-7 | BPG | 1.30 | A | 0.025 | B |
| Example 3 | | | | | | | |
| Comparative | P-1 | I-8 | BEG | 1.37 | A | 0.024 | B |
| Example 4 | | | | | | | |

As shown in Table 5, triethylene glycol monobutyl ether was used as the glycol ether in the ink in the ink set of Example 3. The ink set of Example 3 was rated as good for image density and scratch resistance of the formed images. By contrast, triethylene glycol monoisopropyl ether or triethylene glycol monoethyl ether was used as the glycol ether in the ink in the ink set of Comparative Example 3 or 4. As a result, the ink set of Comparative Example 3 or 4 were rated as poor for scratch resistance of the formed images. From the above, triethylene glycol monobutyl ether is determined to be appropriate as the glycol ether in the ink. Triethylene glycol monoisopropyl ether and triethylene glycol monoethyl ether, while being structurally similar to triethylene glycol monobutyl ether, produced inferior evaluation results.

### <Research 3: Research on Divalent Salts in Pretreatment Liquids>

Pretreatment liquids (P-2) to (P-5) were prepared by the following methods. The aforementioned ink (I-5) and any of the pretreatment liquids (P-2) to (P-5) were combined as shown below in Table 6 to prepare ink sets of Examples 4 and 5 and Comparative Examples 5 and 6. Using the ink sets of Examples 4 and 5 and Comparative Examples 5 and 6, the divalent salts in the pretreatment liquids were researched.

### [Preparation of Pretreatment Liquid (P-2)]

A mixed liquid was obtained by stirring 10 parts by mass of a divalent salt (calcium sulfate for the pretreatment liquid (P-2)) shown below in Table 6, 2 parts by mass of sodium chloride as a monovalent salt, 10 parts by mass of glycerin, and 78 parts by mass of water using a stirrer (“THREE-ONE MOTOR BL-600”, product of Shinto Scientific Co., Ltd.). The mixed liquid was filtered using a filter (pore size 5 μm) to remove foreign matter and the like contained in the mixed liquid. Thus, a pretreatment liquid (P-2) was obtained.

### [Preparation of Pretreatment Liquids (P-3) to (P-5)]

Pretreatment liquids (P-3) to (P-5) were prepared according to the same method as that for preparing the pretreatment liquid (P-2) in all aspects other than that the type of the divalent salt was changed as shown below in Table 6.

Image density and scratch resistance of formed images were evaluated by the aforementioned methods for the ink sets of Examples 4 and 5 and Comparative Examples 5 and 6. The evaluation results are shown below in Table 6.

TABLE 6

| | | | | | | Scratch resistance | |
|---|---|---|---|---|---|---|---|
| | Pretreatment liquid | | | Image density | | Measurement | |
| | Type | Divalent salt | Ink | ID value | Rating | value | Rating |
| Example 4 | P-2 | Calcium sulfate | I-5 | 1.35 | A | 0.016 | A |
| Example 5 | P-3 | Magnesium sulfate | I-5 | 1.33 | A | 0.015 | A |
| Comparative | P-4 | Barium sulfate | I-5 | 1.28 | B | 0.013 | A |
| Example 5 | | | | | | | |
| Comparative | P-5 | Zink sulfate | I-5 | 1.22 | B | 0.014 | A |
| Example 6 | | | | | | | |

As shown in Table 6, calcium sulfate or magnesium sulfate was used as the divalent salt in the pretreatment liquid in the ink set of Example 4 or 5. The ink sets of Examples 4 and 5 were rated as good for image density and scratch resistance of the formed images. By contrast, barium sulfate or zinc sulfate was used as the divalent salt of the pretreatment liquid in the ink set of Comparative Example 5 or 6. As a result, the ink sets of Comparative Examples 5 and 6 were rated as poor for image density of the formed images. From the above, calcium salt or magnesium salt is determined to be appropriate as the divalent salt in the pretreatment liquid. This is thought to be because calcium salt and magnesium salt among the divalent salts have excellent reactivity with pigments.

### <Research 4: Research on Monovalent Salts in Pretreatment Liquids>

Pretreatment liquids (P-6) to (P-9) were prepared by the following methods. The aforementioned ink (I-5) and any of the pretreatment liquids (P-6) to (P-9) were combined as shown below in Table 7 to prepare ink sets of Examples 6 to 8 and Comparative Example 7. Using the ink sets of Examples 6 to 8 and Comparative Examples 7, the monovalent salts in the pretreatment liquids were researched.

### [Preparation of Pretreatment Liquid (P-6)]

A mixed liquid was obtained by stirring 10 parts by mass of magnesium sulfate as a divalent salt, 2 parts by mass of a monovalent salt (sodium chloride for the pretreatment liquid (P-6)) shown below in Table 7, 10 parts by mass of glycerin, and 78 parts by mass of water using a stirrer (“THREE-ONE MOTOR BL-600”, product of Shinto Scientific Co., Ltd.). The mixed liquid was filtered using a filter (pore size 5 μm) to remove foreign matter and the like contained in the mixed liquid. Thus, a pretreatment liquid (P-6) was obtained.

### [Preparation of Pretreatment Liquids (P-7) to (P-9)]

Pretreatment liquids (P-7) to (P-9) were prepared according to the same method as that for preparing the pretreatment liquid (P-6) in all aspects other than that the type of the monovalent salt was changed as shown below in Table 7.

Image density and scratch resistance of formed images were evaluated by the aforementioned methods for the ink sets of Examples 6 to 8 and Comparative Example 7. The evaluation results are shown below in Table 7.

TABLE 7

| | | | | | | Scratch resistance | |
|---|---|---|---|---|---|---|---|
| | Pretreatment liquid | | | Image density | | Measurement | |
| | Type | Monovalent salt | Ink | ID value | Rating | value | Rating |
| Example 6 | P-6 | Sodium chloride | I-5 | 1.35 | A | 0.018 | A |
| Example 7 | P-7 | Lithium chloride | I-5 | 1.36 | A | 0.016 | A |
| Example 8 | P-8 | Potassium chloride | I-5 | 1.37 | A | 0.017 | A |
| Comparative | P-9 | Cesium chloride | I-5 | 1.33 | A | 0.022 | B |
| Example 7 | | | | | | | |

As shown in Table 7, sodium chloride, lithium chloride, or potassium chloride was used as the monovalent salt in the pretreatment liquid in any of the ink sets of Examples 6 to 8. The ink sets of Examples 6 to 8 were rated as good for image density and scratch resistance of the formed images. By contrast, cesium chloride was used as the monovalent salt in the pretreatment liquid in the ink set of Comparative Example 7. As a result, the ink set of Comparative Example 7 was rated as poor for scratch resistance of the formed images. From the above, sodium salt, lithium salt, or potassium salt is determined to be appropriate as the monovalent salt in the pretreatment liquid. This is thought to be because cesium salt among the monovalent salts has low reactivity with pigments.

### <Research 5: Research on Mass Ratio of Salts in Pretreatment Liquids>

Pretreatment liquids (P-10) to (P-14) were prepared by the following methods. The aforementioned ink (I-5) and any of the pretreatment liquids (P-10) to (P-14) were combined as shown below in Table 8 to prepare ink sets of Examples 9 to 11 and Comparative Examples 8 and 9. Using the ink sets of Examples 9 to 11 and Comparative Examples 8 and 9, the ratio of the mass of the divalent salt to the mass of the monovalent salt in each pretreatment liquid was researched.

### [Preparation of Pretreatment Liquids (P-10)]

A mixed liquid was obtained by stirring magnesium sulfate as the divalent salt, sodium chloride as the monovalent salt, 10 parts by mass of glycerin, and water using a stirrer (“THREE-ONE MOTOR BL-600”, product of Shinto Scientific Co., Ltd.). The amounts of the magnesium sulfate and sodium chloride used were as shown below in Table 8. The amount of the water used was an amount that gave the total amount of the mixed liquid 100 parts by mass. Specifically, 10 parts by mass of magnesium sulfate, 1 part by mass of sodium chloride, and 79 parts by mass of water were used in the preparation of the pretreatment liquid (P-10). The mixed liquid was filtered using a filter (pore size 5 μm) to remove foreign matter and the like contained in the mixed liquid. Thus, a pretreatment liquid (P-10) was obtained.

### [Preparation of Pretreatment Liquids (P-11) to (P-14)]

Pretreatment liquids (P-11) to (P-14) were prepared according to the same method as that for preparing the pretreatment liquid (P-10) in all aspects other than that the amounts of the divalent salt and monovalent salt used were changed as shown below in Table 8.

Image density and scratch resistance of formed images were evaluated by the aforementioned methods for the ink sets of Examples 9 to 11 and Comparative Examples 8 and 9. The evaluation results are shown below in Table 8. In Table 8 below, “part” refers to parts by mass. “Ratio X” refers to a ratio of the mass of the corresponding divalent salt to the mass of the corresponding monovalent salt.

TABLE 8

| | Pretreatment liquid | | | | | | | | |
|---|---|---|---|---|---|---|---|---|---|
| | | Divalent | Monovalent | | | | | Scratch resistance | |
| | | salt | salt | Ratio | | Image density | | Measurement | |
| | Type | [part] | [part] | X | Ink | ID value | Rating | value | Rating |
| Example 9 | P-10 | 10 | 1 | 10.0 | I-5 | 1.33 | A | 0.015 | A |
| Example 10 | P-11 | 7 | 1 | 7.0 | I-5 | 1.32 | A | 0.016 | A |
| Example 11 | P-12 | 10 | 2 | 5.0 | I-5 | 1.31 | A | 0.014 | A |
| Comparative | P-13 | 15 | 1 | 15.0 | I-5 | 1.35 | A | 0.025 | B |
| Example 8 | | | | | | | | | |
| Comparative | P-14 | 8 | 2 | 4.0 | I-5 | 1.24 | B | 0.023 | B |
| Example 9 | | | | | | | | | |

As shown in Table 8, the ink sets of Examples 9 to 11 each had a ratio of the mass of the divalent salt to the mass of the monovalent salt of at least 4.5 and no greater than 12.0 in the pretreatment liquid. The ink sets of Examples 9 to 11 were rated as good for image density and scratch resistance of the formed images. By contrast, the ink set of Comparative Example 8 had a ratio of the mass of the divalent salt to the mass of the monovalent salt of greater than 12.0 in the pretreatment liquid. As a result, the ink set of Comparative Example 8 was rated as poor for scratch resistance of the formed images. This is thought to be because an excessive amount of pigment stayed on the recording medium when the divalent salt was too much in the pretreatment liquid. In addition, the ink set of Comparative Example 9 had a ratio of the mass of the divalent salt to the mass of the monovalent salt of less than 4.5 in the pretreatment liquid. As a result, the ink set of Comparative Example 9 was rated as poor for image density and scratch resistance of the formed images. This is thought to be because pigment hardly stayed on the recording medium sheet when the divalent salt was too little in the pretreatment liquid. From the above, the appropriate ratio of the mass of the divalent salt to the mass of the monovalent salt is determined to be at least 4.5 and no greater than 12.0 in the pretreatment liquid.

### <Research 6: Research on Need for Monovalent Salt and Divalent Salt>

Pretreatment liquids (P-15) to (P-18) were prepared by the following methods. The aforementioned ink (1-5) and any of the pretreatment liquids (P-15) to (P-18) were combined as shown below in Table 9 to prepare ink sets of Comparative Examples 10 to 13. The need for a monovalent salt and a divalent salt in the pretreatment liquid was researched using the ink sets of Comparative Examples 10 to 13.

### [Preparation of Pretreatment Liquid (P-15)]

A mixed liquid was obtained by stirring a salt with the type and amount shown below in Table 9 (10 parts by mass of calcium sulfate for the pretreatment liquid (P-15)), 10 parts by mass of glycerin, and water using a stirrer (“THREE-ONE MOTOR BL-600”, product of Shinto Scientific Co., Ltd.). The amount of the water used was an amount that gave the total amount of the mixed liquid 100 parts by mass (80 parts by mass for the pretreatment liquid (P-15)). The mixed liquid was filtered using a filter (pore size 5 μm) to remove foreign matter and the like contained in the mixed liquid. Thus, a pretreatment liquid (P-15) was obtained.

### [Preparation of Pretreatment Liquids (P-16) to (P-18)]

Pretreatment liquids (P-16) to (P-18) were prepared according to the same method as that for preparing the pretreatment liquid (P-15) in all aspects other than that the type and amount of the divalent salt and monovalent salt used were changed as shown below in Table 9.

Image density and scratch resistance of formed images were evaluated by the aforementioned methods for the ink sets of Comparative Examples 10 and 13. The evaluation results are shown below in Table 9. In Table 9 below, “Part” refers to parts by mass. Also, “-” refers to nonuse of a corresponding component.

TABLE 9

| | Pretreatment liquid | | | | | | | | Scratch resistance | |
|---|---|---|---|---|---|---|---|---|---|---|
| | | Divalent salt | | Monovalent salt | | | Image density | | Measurement | |
| | Type | Type | Part | Type | Part | Ink | ID value | Rating | value | Rating |
| Comparative | P-15 | CaSO₄ | 10 | — | — | I-5 | 1.33 | A | 0.025 | B |
| Example 10 | | | | | | | | | | |
| Comparative | P-16 | BaSO₄ | 10 | — | — | I-5 | 1.32 | A | 0.027 | B |
| Example 11 | | | | | | | | | | |
| Comparative | P-17 | — | — | NaCl | 2 | I-5 | 1.20 | B | 0.016 | A |
| Example 12 | | | | | | | | | | |
| Comparative | P-18 | — | — | KCl | 2 | I-5 | 1.22 | B | 0.018 | A |
| Example 13 | | | | | | | | | | |

As shown in Table 9, the pretreatment liquids of the ink sets of Comparative Examples 10 and 11 did not contain a monovalent salt. As a result, the ink sets of Comparative Examples 10 and 11 were rated as poor for scratch resistance of the formed images. From comparison between Examples 1 to 11 and Comparative Examples 10 and 11, it was confirmed that addition of a monovalent salt to a pretreatment liquid imparts scratch resistance to formed images. The pretreatment liquids of the ink sets of Comparative Examples 12 and 13 did not contain a divalent salt. The ink sets of Comparative Examples 12 and 13 were rated as poor for image density of the formed images. From comparison between Examples 1 to 11 and Comparative Examples 12 and 13, it was confirmed that addition of a divalent salt to a pretreatment liquid imparts desired image density to formed images.

To summarize the above, the ink sets of Examples 1 to 11 each included an ink and a pretreatment liquid. The ink contained a pigment, a pigment coating resin, and a first aqueous medium. The first aqueous medium contained water, triethylene glycol monobutyl ether, and a diol with a carbon number of 6. The pretreatment liquid contained a monovalent salt, a divalent salt, and a second aqueous medium. The monovalent salt included at least one of sodium salt, lithium salt, and potassium salt. The divalent salt included at least one of calcium salt and magnesium salt. The ratio of the mass of the divalent salt to the mass of the monovalent salt was at least 5.0 and no greater than 12.0 in the pretreatment liquid. The ink sets of Examples 1 to 11 were rated as good for image density and scratch resistance of the formed images.

By contrast, the ink sets of Comparative Examples 1 to 13 did not meet at least one of the above features. As a result, the ink sets of Comparative Examples 1 to 13 were rated as poor for at least one of image density and scratch resistance of the formed images.

What is claimed is:

1. An ink set comprising:
an inkjet ink; and
a pretreatment liquid, wherein
the inkjet ink contains a pigment, a pigment coating resin, and a first aqueous medium,
the first aqueous medium contains water, triethylene glycol monobutyl ether, and a diol with a carbon number of 6,
the pretreatment liquid contains a monovalent salt, a divalent salt, and a second aqueous medium,
the monovalent salt includes at least one of sodium salt, lithium salt, and potassium salt,
the divalent salt includes at least one of calcium salt and magnesium salt, and
a ratio of a mass of the divalent salt to a mass of the monovalent salt is at least 4.5 and no greater than 12.0 in the pretreatment liquid.

2. The ink set according to claim 1, wherein
the diol with a carbon number of 6 has a percentage content of at least 15.0% by mass and no greater than 25.0% by mass in the inkjet ink.

3. The ink set according to claim 1, wherein
the triethylene glycol monobutyl ether has a percentage content of at least 3.0% by mass and no greater than 7.0% by mass in the inkjet ink.

4. The ink set according to claim 1, wherein
the divalent salt includes at least one of calcium sulfate and magnesium sulfate.

5. The ink set according to claim 1, wherein
the monovalent salt includes at least one of sodium chloride, lithium chloride, and potassium chloride.

6. The ink set according to claim 1, wherein
the monovalent salt has a percentage content of at least 1.0% by mass and no greater than 3.0% by mass in the pretreatment liquid.

7. The ink set according to claim 1, wherein
the divalent salt has a percentage content of at least 5.0% by mass and no greater than 15.0% by mass in the pretreatment liquid.

8. The ink set according to claim 1, wherein
the second aqueous medium contains water and glycerin.

9. The ink set according to claim 1, wherein
the pretreatment liquid contains only the monovalent salt and the divalent salt as solid contents.

10. An inkjet recording apparatus that forms an image on an image formation area of a recording medium, comprising:
the ink set according to claim 1;
a line-type pretreatment head that ejects the pretreatment liquid onto the image formation area; and
a line-type recording head that ejects the inkjet ink onto the image formation area.

11. An inkjet recording method for forming an image on an image formation area of a recording medium with the ink set according to claim 1, comprising:
performing pretreatment by ejecting the pretreatment liquid onto the image formation area; and
performing image formation by ejecting the inkjet ink onto the image formation area.
